(19) United States
(12) Patent Application Publication
(10) Pub. No.: US 2022/0408150 A1
(43) Pub. Date: Dec. 22, 2022

(54) SERVER DEVICE, METHOD, AND TRANSMISSION DEVICE

(71) Applicant: KABUSHIKI KAISHA TOSHIBA, Tokyo (JP)

(72) Inventor: Ichiro TOMODA, Hamura (JP)

(73) Assignee: KABUSHIKI KAISHA TOSHIBA, Tokyo (JP)

(21) Appl. No.: 17/653,577

(22) Filed: Mar. 4, 2022

(30) Foreign Application Priority Data
Jun. 16, 2021 (JP) 2021-100237

(51) Int. Cl. H04N 21/4363; H04N 21/24; H04N 21/2343

(52) U.S. Cl. CPC H04N 21/43635; H04N 21/2404; H04N 21/234309

(57) ABSTRACT

According to one embodiment, a server device is communicably connected to a plurality of video distribution systems each including a transmission device, a receiving device and an HDMI cable. The server device is configured to aggregate the plurality of elements of received first data, for each combination of the type of the receiving device and the type of the HDMI cable that is indicated by each element of the first data. The server device is configured to select a video format optimum for the video distribution system based on first data. The server device is configured to transmit second data to cause the optimum video format to be selected to the transmission device transmitting the particular first data.

### CROSS-REFERENCE TO RELATED APPLICATIONS

This application is based upon and claims the benefit of priority from Japanese Patent Application No. 2021-100237, filed Jun. 16, 2021, the entire contents of which are incorporated herein by reference.

### FIELD

Embodiments described herein relate generally to a server device, a method, and a transmission device.

### BACKGROUND

In recent years, HDMI (registered trademark) cables have become widespread and are used in various situations. In contrast, when video data is displayed using an HDMI cable, an appropriate video format according to performance of a source device that transmits the video data, a sink device that receives and displays the video data, and an HDMI cable that connects the source device and the sink device needs to be selected. Since the selection of the video format needs to be executed after exactly recognizing the performance of the source device and the HDMI cable, the selection is a very difficult work for a user having only general knowledge since.

### BRIEF DESCRIPTION OF THE DRAWINGS

FIG. 1 is a block diagram showing a schematic configuration example of a system according to one of embodiments.

FIG. 2 is a block diagram showing functional configuration examples of a source device, a sink device, and an HDMI cable according to the embodiment.

FIG. 3 is a block diagram showing a functional configuration example of the server device according to the embodiment.

FIG. 4 is a table showing an example of a data structure of aggregate result data according to the embodiment.

FIG. 5 is a sequence chart showing an example of an operation of a system according to the embodiment.

FIG. 6 is a view showing a screen example displayed in the system according to the embodiment.

FIG. 7 is a view showing another screen example displayed in the system according to the embodiment.

FIG. 8 is a view showing yet another screen example displayed in the system according to the embodiment.

FIG. 9 is a view showing a first example of the system according to the embodiment.

FIG. 10 is a view showing a second example of the system according to a comparative example.

### DETAILED DESCRIPTION

In general, according to one embodiment, a server device is communicably connected to a plurality of video distribution systems each including a transmission device transmitting video data, a receiving device receiving the video data, and an HDMI cable connecting the transmission device and the receiving device to each other. The server device includes a receiving unit, an aggregation unit and a transmission unit. The receiving unit is configured to receive first data that is transmitted by the transmission device included in each of the plurality of video distribution systems and that indicates a type and a capability related to video transmission, of the receiving device, and a type and a capability related to video transmission, of the HDMI cable. The aggregation unit is configured to aggregate the plurality of elements of the received first data, for each combination of the type of the receiving device and the type of the HDMI cable that is indicated by each element of the first data. The aggregation unit is configured to store the first data in a memory. The transmission unit is configured to select a video format optimum for the video distribution system including the transmission device transmitting particular first data, based on first data which is indicated by the received particular first data and which indicates the same combination as a combination of the type of the receiving device and the type of the HDMI cable, among the plurality of elements of the first data stored in the memory. The transmission unit is configured to transmit second data to cause the optimum video format to be selected to the transmission device transmitting the particular first data.

Embodiments will be described hereinafter with reference to the accompanying drawings.

The disclosure is merely an example, and proper changes within the spirit of the invention, which are easily conceivable by a skilled person, are included in the scope of the invention as a matter of course. Besides, in the specification and drawings, structural elements performing the functions that are the same as or similar to those described above in connection with preceding drawings are denoted by like reference numerals, detailed description thereof being omitted unless necessary.

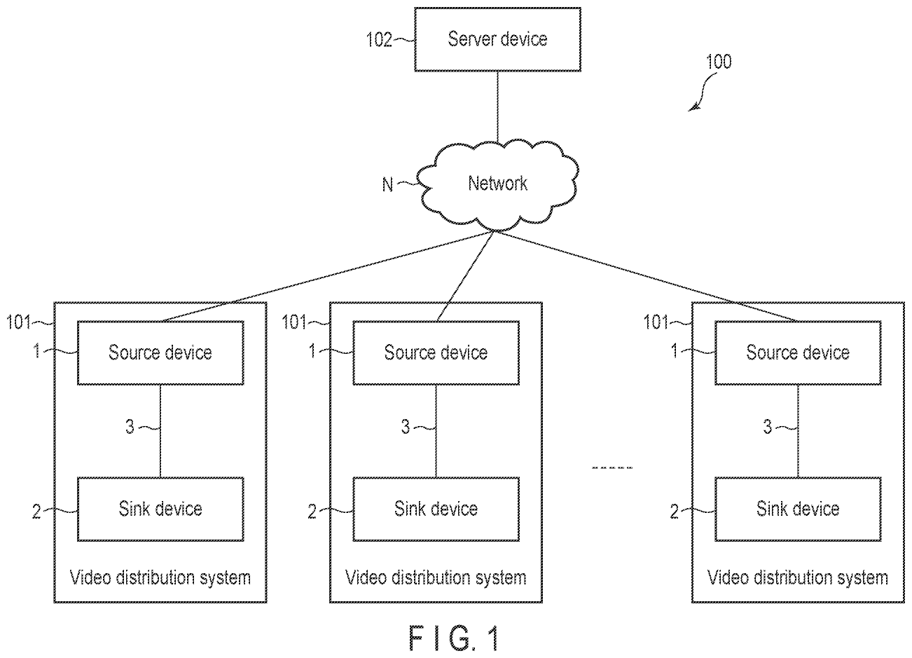

FIG. 1 is a block diagram showing a schematic configuration example of a system 100 according to one of embodiments. As shown in FIG. 1, the system 100 comprises a plurality of video distribution systems 101 and a server device 102. The plurality of video distribution systems 101 include source devices 1 that transmit video data and audio data, sink devices 2 that receive video data and audio data, and a source device 1 and sink device 2, and High-Definition Multimedia

Interface (HDMI) cables 3, respectively. The server device 102 is communicably connected to the source devices 1 which are included in the plurality of video distribution systems 101, respectively, via a network N. The source device 1 may be referred to as a transmission device. The sink device 2 may be referred to as a receiving device.

The source device 1 includes an optical disc player, a set-top box, a video camera, a personal computer, a smartphone, or the like. The sink device 2 includes a television receiver, a monitor, a projector, a personal computer, a smartphone, a digital signage, or the like. The server device 102 includes a server device that executes a cloud computing service.

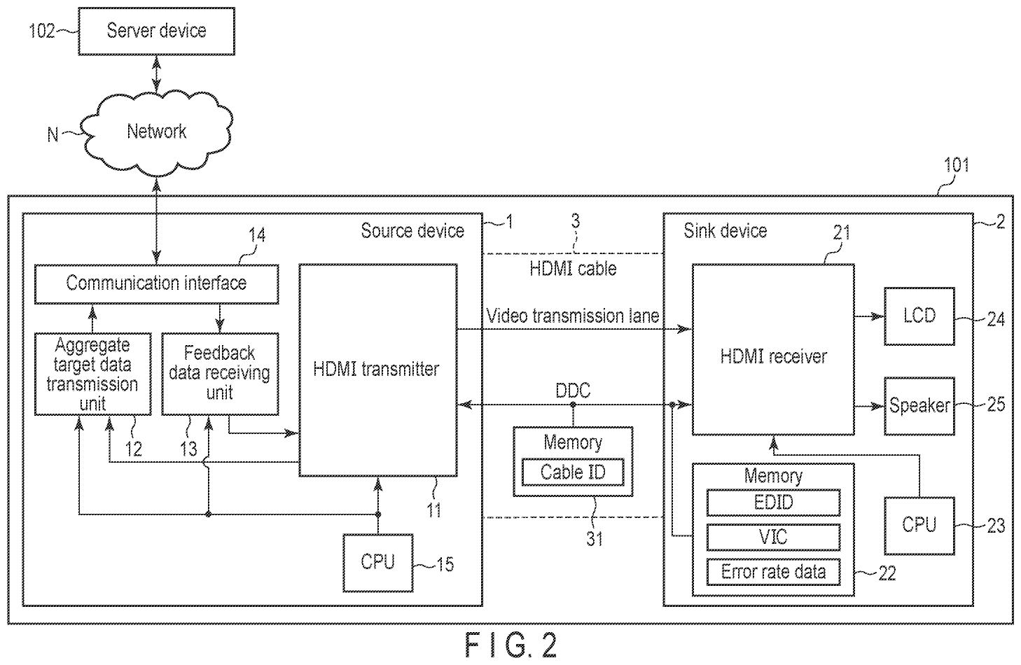

First, the source device 1, the sink device 2, and the HDMI cable 3 included in the video distribution system 101 will be described below in detail with reference to FIG. 2.

FIG. 2 is a block diagram showing functional configuration examples of the source device 1, the sink device 2, and the HDMI cable 3 according to the present embodiment. As shown in FIG. 2, the source device 1 includes an HDMI transmitter 11, an aggregate target data transmission unit 12, a feedback data receiving unit 13, a communication interface 14, and a CPU 15. The communication interface 14 is a module which enables communication with the server device 102 to be executed. The CPU 15 controls operations of the HDMI transmitter 11, the aggregate target data transmission unit 12, and the feedback data receiving unit 13.

The HDMI transmitter 11 transmits video data and audio data to the sink device 2 in Transition Minimized Differential Signaling (TMDS) using a video transmission lane of the HDMI cable 3.

The HDMI transmitter 11 comprises a video format selection function of selecting a video format of the video data to be transmitted to the sink device 2. The video format includes various parameters such as resolution, frame rate, color depth, chroma sub-sampling, colorimetry, High Dynamic Range (HDR) metadata, and Display Stream Compression (DSC) compression.

In addition to the above-described video format selection function, the HDMI transmitter 11 further comprises a link training function. According to the link training function, the HDMI transmitter 11 transmits test pattern data to the sink device 2 at several predetermined transmission rates on a trial basis when the source device 1 is connected to the sink device 2 using the HDMI cable 3. After that, when the sink device succeeds in receiving and matching the test pattern data, the sink device transmits a notification of success of the test pattern matching to the source device. Then, the HDMI transmitter 11 selects the highest transmission rate of the transmission rates at which the sink device succeeds in test pattern reception and matching, and selects the video format of the highest resolution that can be transmitted at the selected transmission rate, as the first video format.

The HDMI transmitter 11 acquires data indicative of the capability of the sink device 2 for video transmission using Display Data Channel (DDC) of the HDMI cable 3. More specifically, the HDMI transmitter 11 acquires from the sink device 2 Extended Display Information Data (EDID), Video Information Code (VIC) for specifying the currently selected video format, and error rate data indicative of the error rate of the video data transmitted in the currently selected video format, as the data indicative of the capability of the sink device 2 for video transmission. The EDID is a data set indicative of the manufacturer's name of the sink device 2 and its model number (i.e., the type of the sink device 2), and the function and the performance supported by the sink device 2.

In addition, the HDMI transmitter 11 acquires a cable ID from the HDMI cable 3 as data indicative of the capability of the HDMI cable 3 for video transmission by using the DDC of the HDMI cable 3. The cable ID is a data set indicative of the manufacturer's name of the HDMI cable 3 and its model number (i.e., the type of the HDMI cable 3), and the function and the performance supported by the HDMI cable 3.

The aggregate target data transmission unit 12 collects the EDID, the VIC and the error rate data of the device 2 that are acquired by the HDMI transmitter 11, and the cable ID of the HDMI cable 3, from the HDMI transmitter 11. The aggregate target data transmission unit 12 generates aggregate target data (first data) obtained by attaching a device ID for specifying the source device 1 (i.e., the own device) to the data collected from the HDMI transmitter 11 and transmits the generated aggregate target data to the server device 102 via the network N.

The feedback data receiving unit 13 comprises a function of receiving the feedback data transmitted from the server device 102 and causing the HDMI transmitter 11 to select the video format indicated by the received feedback data as the video format of the video data to be transmitted to the sink device 2, which will be described later.

The sink device 2 includes an HDMI receiver 21, a memory 22, a CPU 23, an LCD display 24, and a speaker 25. The CPU 23 controls the operation of the HDMI receiver 21.

The HDMI receiver 21 receives the video data and audio data transmitted from the source device 1, causes the video data to be displayed on the LCD display 24 and causes the audio data to be output from the speaker 25. The memory 22 is a nonvolatile memory, and the EDID, the VIC and the error rate data described above are stored in the memory 22.

The HDMI cable 3 includes a memory 31. The memory 31 is a nonvolatile memory, and the above-described cable ID is stored in the memory 31.

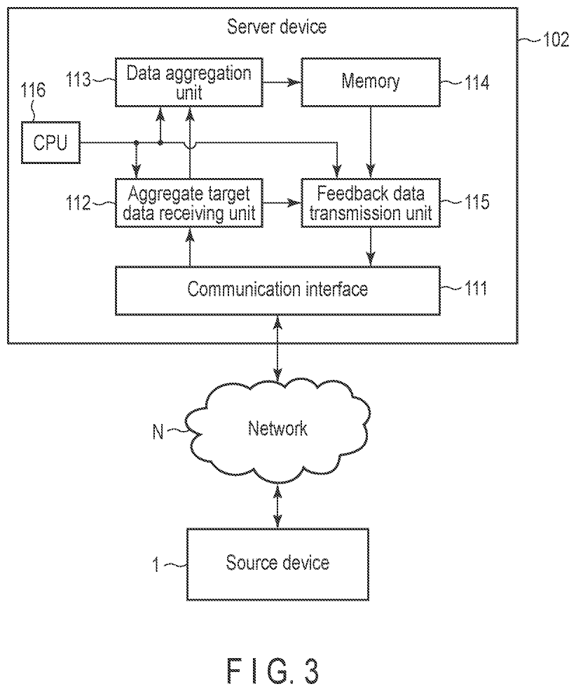

FIG. 3 is a block diagram showing a functional configuration example of the server device 102 according to the present embodiment. As shown in FIG. 3, the server device 102 includes a communication interface 111, an aggregate target data receiving unit 112, a data aggregation unit 113, a memory 114, a feedback data transmission unit 115, and a CPU 116. The CPU 116 controls operations of the aggregate target data receiving unit 112, the data aggregation unit 113, and the feedback data transmission unit 115. The communication interface 111 is a module which enables communication with the source device 1.

The aggregate target data receiving unit 112 receives a plurality of aggregate target data elements transmitted from a large number of source devices 1 communicatively connected via a network N. The received aggregate target data is sequentially transmitted to the data aggregation unit 113 and the feedback data transmission unit 115.

The data aggregation unit 113 classifies and aggregates a large number of elements of the aggregate target data received by the aggregate target data receiving unit 112 in accordance with a combination of the EDID and the cable ID included in the aggregate target data, and stores the data in the memory 114.

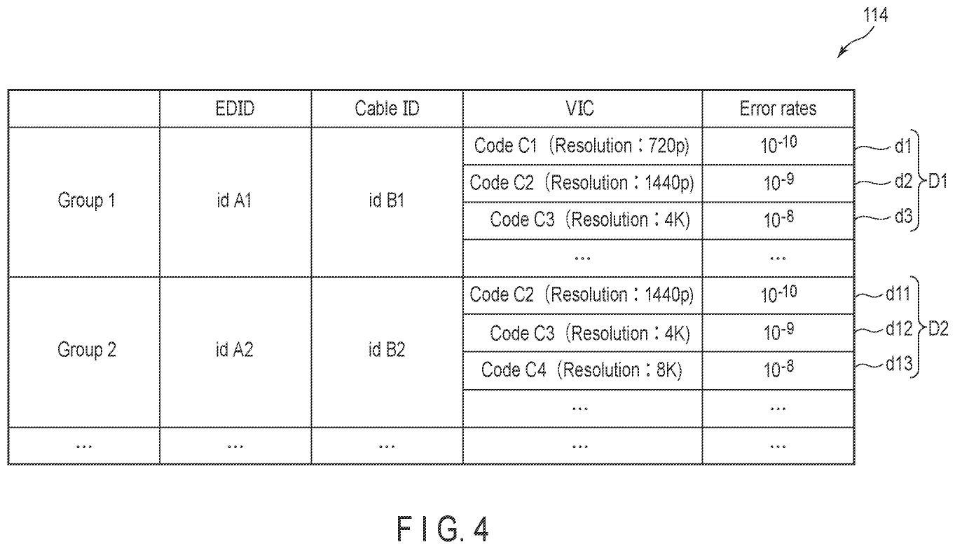

The memory 114 is a nonvolatile memory, and the aggregate result data indicating the aggregate result of the data aggregation unit 113 is stored in the memory 114. A data structure of the aggregate result data stored in the memory 114 will be described with reference to FIG. 4.

FIG. 4 is a table showing an example of the data structure of the aggregate result data stored in the memory 114. As shown in FIG. 4, in the memory 114, a number of aggregate target data elements are classified into a plurality of groups created based on combinations of the EDID and the cable IDs, which are stored in the memory 114, and the aggregate of the aggregate target data included in each group corresponds to the aggregate result data.

For example, “group 1” shown in FIG. 4 is a group in which aggregate target data d1 to d3 including EDID “id A1” and cable ID “id B1” are collected, and the aggregate of the aggregate target data d1 to d3 corresponds to aggregate result data D1. In addition, “group 2” shown in FIG. 4 is a group in which aggregate target data d11 to d13 including EDID “id A2” and cable ID “id B2” are collected, and the aggregate of the aggregate target data d11 to d13 corresponds to aggregate result data D2.

According to the aggregate target data d1 included in the aggregate result data D1, it is indicated that when the HDMI transmitter 11 included in the source device 1 is connected to the sink device 2 having a transmission capacity indicated by the EDID “id A1” by using the HDMI cable 3 having the transmission capacity indicated by the cable ID “id B1”, the HDMI transmitter 11 transmits the video data to the sink device 2 in the video format specified by VIC “code C1 (resolution: 720p)”, and the error rate of the video data at that time is “10−10”(10 to the power of minus 10).

In addition, according to the aggregate target data d2 included in the aggregate result data D1, it is indicated that when the HDMI transmitter 11 included in the source device 1 is connected to the sink device 2 having a transmission capacity indicated by the EDID “id A1” by using the HDMI cable 3 having the transmission capacity indicated by the cable ID “id B1”, the HDMI transmitter 11 transmits the video data to the sink device 2 in the video format specified by VIC “code C2 (resolution: 1440p)”, and the error rate of the video data at that time is “10−9” (10 to the power of minus 9).

Furthermore, according to the aggregate target data d3 included in the aggregate result data D1, it is indicated that when the HDMI transmitter 11 included in the source device 1 is connected to the sink device 2 having a transmission capacity indicated by the EDID “id A1” by using the HDMI cable 3 having the transmission capacity indicated by the cable ID “id B1”, the HDMI transmitter 11 transmits the video data to the sink device 2 in the video format specified by VIC “code C3 (resolution: 4K)”, and the error rate of the video data at that time is “10−8” (10 to the power of minus 8).

For convenience of explanation, only the aggregate result data D1 and the aggregate target data d1 to d3 included in the aggregate result data D1 will be described in detail here, and the other data stored in the memory 114 such as the aggregate result data D2 and the aggregate target data d11 to d13 included in the aggregate result data D2 shown in FIG. 4 can also be described similarly to the above-described aggregate result data D1 and aggregate target data d1 to d3 included in the aggregate result data D1.

Description will return to FIG. 3 again.

The feedback data transmission unit 115 selects the optimum video format for the video distribution system 101 including the source device 1 indicated by the device ID included in the aggregate target data received by the aggregate target data receiving unit 112, based on the aggregate result data stored in the memory 114.

More specifically, the feedback data transmission unit 115 refers to the aggregate result data including the same combination of EDID and the cable ID as the combination of the EDID and the cable ID included in the received aggregate target data, among the aggregate result data stored in the memory 114, and selects the video format in which the error rate indicates a value lower than or equal to a threshold value (10−9 in this example) and in which the video format resolution specified by the VIC is the highest, of the aggregate target data included in the aggregate result data, as the optimum video format. The threshold value set for the error rate is set based on, for example, the standard specification of HDMI, and is assumed to be set to 10−9 (10 to the power of minus 9) as described above.

The feedback data transmission unit 115 generates feedback data (second data) including the VIC for specifying the selected optimum video format, and transmits the feedback data to the source device 1 indicated by the device ID included in the received aggregate target data.

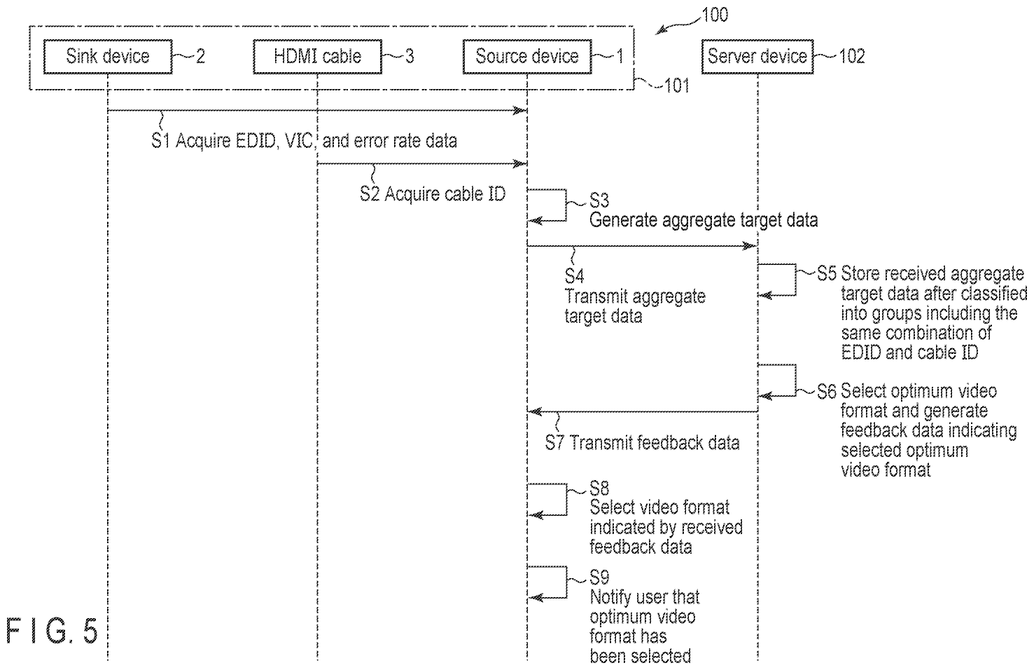

Next, an example of an operation of the system 100 comprising the video distribution system 101 including the source device 1, the sink device 2, and the HDMI cable 3 configured as described above, and the server device 102 configured as described above will be described with reference to a sequence chart of FIG. 5.

First, the HDMI transmitter 11 of the source device 1 acquires the EDID, the VIC and the error rate data from the sink device 2 connected via the HDMI cable 3, by using the DDC of the HDMI cable 3 (step S1). Then, the HDMI transmitter 11 acquires the cable ID from the HDMI cable 3 by using the DDC of the HDMI cable 3 (step S2).

The aggregate target data transmission unit 12 of the source device 1 collects the EDID, the VIC, the error rate data, and the cable ID acquired by the processes of steps S1 and S2 from the HDMI transmitter 11, and generates the aggregate target data by attaching the device ID of the source device 1 (own device) to the collected data (step S3). The aggregate target data transmission unit 12 transmits the generated aggregate target data to the server device 102 communicatively connected via the network N (step S4).

When the aggregate target data transmitted from the source device 1 is received by the aggregate target data receiving unit 112, the data aggregation unit 113 of the server device 102 classifies the received aggregate target data into the group including the same combination of the EDID and the cable ID as the combination of the EDID and the cable ID included in the aggregate target data, and stores the data in the memory 114 as an element of the aggregate result data corresponding to the group (step S5).

When the group including the same combination of the EDID and the cable ID as the combination of the EDID and the cable ID included in the received aggregate target data is not stored in the memory 114, the data aggregation unit 113 creates a new group corresponding to the combination in the memory 114 and stores the received aggregate target data in the memory 114 as an element of the aggregate result data corresponding to the new group.

When the aggregate target data transmitted from the source device 1 is received by the aggregate target data receiving unit 112, the feedback data transmission unit 115 of the server device 102 refers to the aggregate result data including the EDID and the cable ID included in the received aggregate target data, and selects the video format in which the error rate indicates a value smaller than or equal to a threshold value and in which the resolution of the video format specified by the VIC is the highest, of the aggregate target data included in the aggregate result data, as the optimum video format. Then, the feedback data transmission unit 115 generates the feedback data including the VIC for specifying the selected optimum video format (step S6).

After that, the feedback data transmission unit 115 of the server device 102 transmits the generated feedback data to the source device 1 indicated by the device ID included in the received aggregate target data (step S7).

When receiving the feedback data transmitted from the server device 102, the feedback data receiving unit 13 of the source device 1 notifies the HDMI transmitter 11 of the video format specified by the VIC included in the received feedback data and causes the HDMI transmitter 11 to select the video format (step S8). According to this, the HDMI transmitter 11 selects the video format indicated by the feedback data as the video format of the video data transmitted to the sink device 2.

After that, the feedback data receiving unit 13 of the source device 1 notifies the user that the video format optimum for the video distribution system 101 including the source device 1 has been selected (step S9), and ends a series of operations.

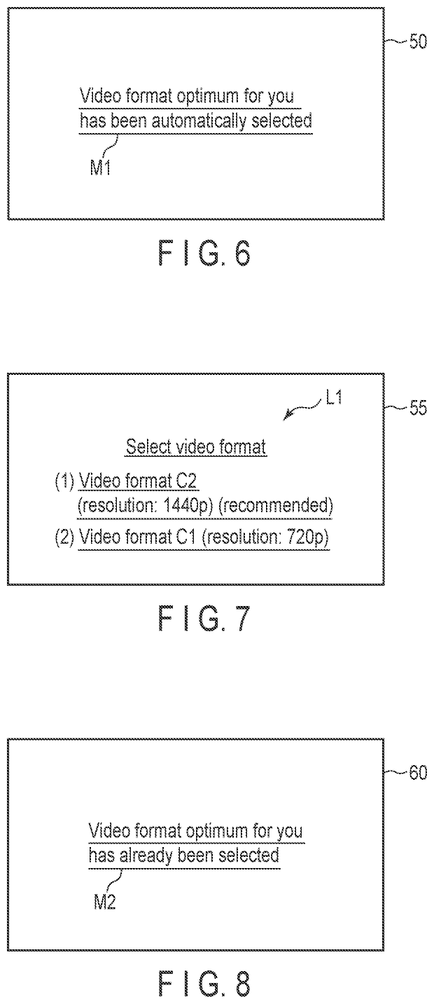

An example of the method of notifying the user that the optimum video format has been selected is a method of notifying by displaying, for example, a screen 50 shown in FIG. 6, more specifically, a screen 50 including a message M1 such as “Video format optimum for you has been automatically selected”. The screen 50 shown in FIG. 6 may be displayed on the sink device 2 or, if the source device 1 comprises a display, may be displayed on the source device 1. Alternatively, the user may be notified that the optimum video format has been selected, by not displaying the screen 50 shown in FIG. 6, but outputting voice of the message M1 included in the screen 50. In this case, too, the message M1 may be output from the sink device 2 or, if the source device 1 comprises a speaker, the voice may be output from the source device 1.

The series of operations shown in FIG. 5 is periodically executed by transmitting the aggregate target data from the source device 1 to the server device 102 at predetermined intervals, for example, every other day. In contrast, the server device 102 may autonomously execute the processes of generating and transmitting the feedback data in the server device 102, i.e., the processes of steps S6 and S7 shown in FIG. 5 at not only the timing of receiving the aggregate target data transmitted from the source device 1, but also, for example, the timing at which more than a predetermined amount of data is collected in the memory 114 of the server device 102, the timing at which the data transmitted from the other source device 1 is stored in the memory 114 of the server device 102, or the like. According to this, the server device 102 can execute the processes of steps S6 and S7 for the source device 1 at not only the timing of receiving the aggregate target data transmitted from the source device 1, but also various timing.

When the server device 102 autonomously executes the processes of steps S6 and S7 shown in FIG. 5, it is necessary to determine to which source device 1 the feedback data is generated and transmitted, and it is assumed that the aggregate target data is stored in a state of including the device ID for specifying the source device 1, in the memory 114 of the server device 102. According to this, the server device 102 can execute the above-described processes of steps S6 and S7 by referring to the aggregate result data including the aggregate target data including the device ID of the source device 1 that generates and transmits the feedback data.

The above-described processes of steps S6 and S7 will be described below while assuming a specific situation. More specifically, the processes of the feedback data transmission unit 115 in a case where the aggregate target data including the EDID “id A1” and the cable ID “id B1” is received by the aggregate target data receiving unit 112 included in the server device 102 will be described. In the following descriptions, it is assumed that the aggregate result data D1 shown in FIG. 4 is at least stored in the memory 114.

When the aggregate target data including the EDID “id A1” and the cable ID “id B1” is received by the target data receiving section 112, the feedback data transmission unit 115 refers to the aggregate result data D1 including the EDID “id A1” and the cable ID “id B 1”, among the aggregate result data stored in the memory 114, and extracts the aggregate target data indicating the error rate of 10−9 (10 to the power of minus 9) or less as candidate data. In this case, since the error rate of the aggregate target data d1 is “10−10” (10 to the power of minus 10), the error rate of the aggregate target data d2 is “10−9” (10 to the power of minus 9), and the error rate of the aggregate target data d3 is “10−8” (10 to the power of minus 8), the aggregated target data d1 and the aggregate target data d2 are extracted as candidate data.

Next, the feedback data transmission unit 115 selects the video format of the highest resolution among the video formats specified by the VICs included in each of the extracted aggregated target data d1 and d2, as the optimum video format. In this case, since the resolution of the video format specified by VIC “code C1” included in the aggregate target data d1 is “720p” while the resolution of the video format specified by VIC “code C2” included in the aggregate target data d2 is “1440p”, the video format specified by VIC “code C2” included in the aggregate target data d2 is selected as the optimum video format.

After that, the feedback data transmission section 115 generates the feedback data including VIC “code C2” for specifying the video format selected as the optimum video format, and transmits the feedback data to the source device 1 indicated by the device ID included in the received aggregate target data.

As described above, according to the feedback data transmission unit 115 of the present embodiment, a video format having a lowest error rate is not merely selected as the optimum video format, but the video format that has an error rate lower than or equal to a threshold value and that has the highest resolution among the video formats can be selected as the optimum format.

In the present embodiment, the feedback data includes only the VIC for specifying the selected optimum video format, but the feedback data is not limited to this and may further include, for example, a VIC corresponding to a video format having the error rate lower than or equal to a threshold value and having the resolution lower than that of the optimum video format, or the like.

When feedback data including a plurality of VICs is generated in the server device 102 and the feedback data is transmitted to the source device 1, the feedback data receiving unit 13 of the source device 1 may cause a screen 55 shown in FIG. 7 to be displayed, more specifically, the screen 55 including a list L1 indicating a plurality of video formats specified by a plurality of VICs included in the received feedback data, and may allow the user to select the video format that is to be selected by the HDMI transmitter 11, from the list L1. The user may be notified which video format is the optimum video format by attaching a word “recommended” or the like to the optimum video format in the list L1 included in the screen 55 shown in FIG. 7. The screen 55 shown in FIG. 7 may be displayed on the sink device 2 or, if the source device 1 comprises a display, may be displayed on the source device 1, similarly to the screen 50 shown in FIG. 6.

In addition, in the present embodiment, it has been described that the feedback data receiving unit 13 of the source device 1 causes the HDMI transmitter 11 to select the optimum video format specified by the VIC included in the received feedback data and then causes the screen 50 shown in FIG. 6 to be displayed, and notifies the user that the optimum video format has been selected. For example, however, when causing the HDMI transmitter 11 to select the optimum video format, if the optimum video format has already been selected in the HDMI transmitter 11, the feedback data receiving section 13 may notify the user that the video format has already been optimized, by causing a screen 60 shown in FIG. 8 to be displayed, more specifically, a screen 60 including a message M2 such as “Video format optimum for you has already been selected”. The screen 60 shown in FIG. 8 may be displayed on the sink device 2 or, if the source device 1 comprises a display, may be displayed on the source device 1, similarly to the screen 50 shown in FIG. 6 and the screen 55 shown in FIG. 7.

In the above-described embodiment, the server device 102 comprises the aggregate target data receiving unit 112 receiving the aggregate target data that is transmitted by the source devices 1 included in the plurality of video distribution systems 101, respectively, and that indicates the type and the capability related to video transmission, of the sink device 2, and the type and the capability related to video transmission, of the HDMI cable 3. In addition, the server device 102 comprises the data aggregation unit 113 that aggregates the plurality of elements of received aggregate target data, for each set of the type (EDID) of the sink device 2 and the type (cable ID) of the HDMI cable 3 that is indicated by each element of the aggregate target data, and that stores the aggregated data in the memory 114. Furthermore, the server device 102 comprises the feedback data transmission unit 115 that selects the video format optimum for the video distribution system 101 including the source device 1 transmitting the particular aggregate target data and transmits the feedback data for selecting the optimum video format to the source device 1, based on the aggregate result data including the aggregate target data indicating the same combination of the type of sink device 2 and the type of HDMI cable 3, which is indicated by the received particular aggregate target data, among the plurality of elements of the aggregate target data stored in the memory 114.

In addition, in the above-described embodiment, the source device 1 comprises the HDMI transmitter 11 that selects a particular video format and transmits the video data to the sink device 2. Moreover, the source device 1 comprises the aggregate target data transmission unit 12 that acquires the data indicating the type and the capability related to video transmission, of the sink device 2, and the data indicating the type and the capability related to video transmission, of the HDMI cable 3, generates the aggregate target data by attaching the device ID for specifying the source device 1 (own device) to the data acquired from the sink device 2 and the data acquired from the HDMI cable 3, and transmits the aggregate target data to the server device 102. Moreover, the source device 1 comprises the feedback data receiving unit 13 that receives from the server device 102 the feedback data indicating the optimum video format of the video data transmitted to the sink device 2 via the HDMI cable 3, and causes the HDMI transmitter 11 to select the optimum video format indicated by the feedback data.

According to this, the optimum video format for displaying the video data on the sink device 2 using the HDMI cable 3 can easily be selected. In addition, even if a problem that video transmission cannot be executed or the like occurs in a certain video distribution system 101, the video format optimum for the certain video distribution system 101 can be selected based on the aggregate result data indicating the operation status (VIC and error rate) of the other video distribution system 101 including the same combination of the sink device 2 and the HDMI cable 3 as that in this video distribution system 101, and the above problem can be thereby solved.

Examples of the system 100 according to the present embodiment will be described below.

### First Embodiment

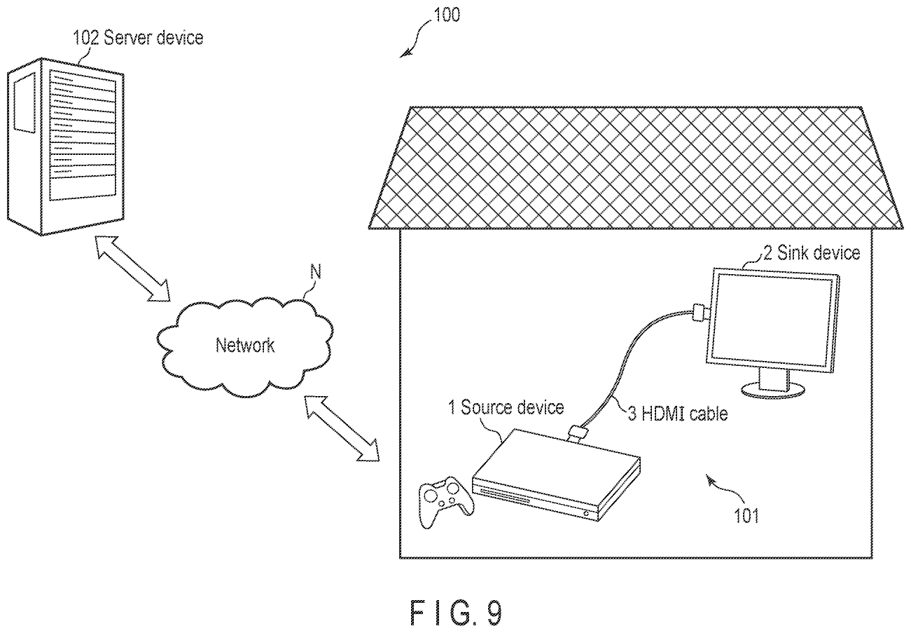

FIG. 9 is a view showing a first example of the system 100 according to the present embodiment. As shown in FIG. 9, in the first example, a home game device corresponds to the source device 1, and a display connected to the home game device via the HDMI cable 3 corresponds to the sink device 2. The home game device corresponding to the source device 1 is communicably connected to the server device 102 via the network N. In this case, according to the system 100 of the present embodiment, the video format of the video data transmitted from the home game device to the display can easily be optimized, and the video format setting the user can enjoy the game with high-definition video data without performing a difficult work such as setting the video format.

### Second Embodiment

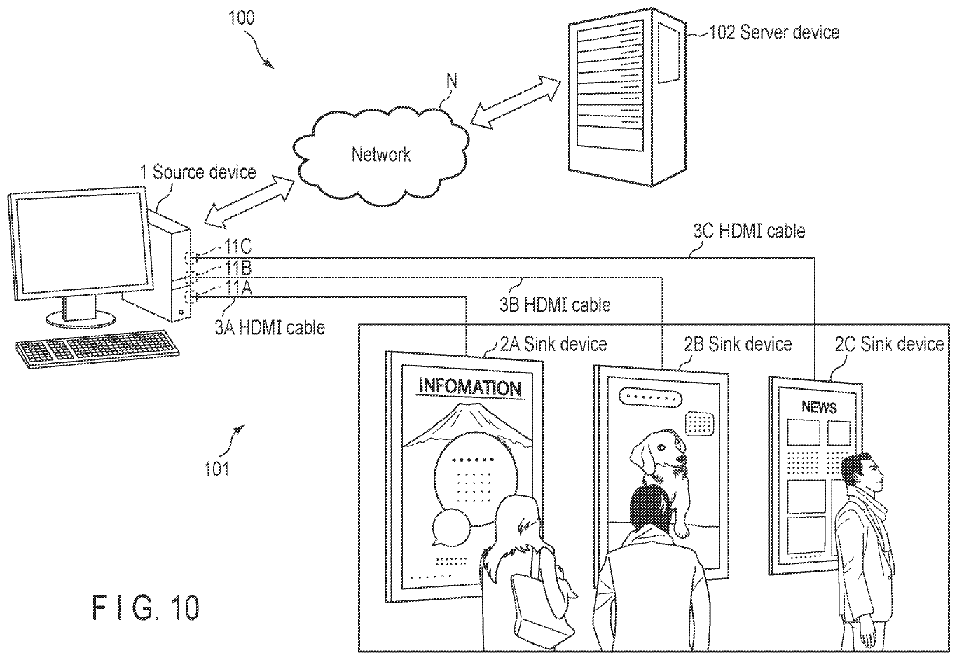

FIG. 10 is a view showing a second example of the system 100 according to the present embodiment. As shown in FIG. 10, in the second example, a personal computer (PC) installed in facilities such as office buildings, shopping malls, schools, or stations corresponds to the source device 1, HDMI cables 3A to 3C are inserted into a plurality of HDMI ports provided on the PC, and digital signage devices connected via the HDMI cables 3A to 3C correspond to sink devices 2A to 2C, respectively. The PC corresponding to the source device 1 is communicatively connected to the server device 102 via the network N.

As shown in FIG. 10, when the PC is provided with a plurality of HDMI ports, HDMI transmitters 11A to 11C corresponding to the respective HDMI ports are provided on the source device 1. The aggregate target data transmission unit 12 of the source device 1 collects the EDID, VIC, and error rate data of the sink device 2A and the cable ID of the HDMI cable 3A from the HDMI transmitter 11A, and generates the aggregate target data to the HDMI transmitter 11A. Similarly, the aggregate target data transmission unit 12 also collects the EDID, VIC, and error rate data of the sink devices 2B and 2C and the cable IDs of the HDMI cables 3B and 3C, respectively, and generates the aggregate target data corresponding to the HDMI transmitters 11B and 11C, respectively. The feedback data receiving unit 13 of the source device 1 receives the feedback data corresponding to each of the HDMI transmitters 11A to 11 C and causes each of the HDMI transmitters 11A to 11C to select the optimum video format.

In the above-described second example, too, according to the system 100 of the present embodiment, it is possible to easily optimize the video format of the video data (for example, advertisement, live distribution video, and the like) transmitted from a PC to a plurality of elements of the digital signage and to provide the users of the above-described facilities with high-definition video data without performing a difficult work such as setting of the video format. In addition, according to the system 100 of the present embodiment, labor of an administrator (user) who manages a plurality of elements of the digital signage can be greatly reduced since setting the video format can be automated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server device communicably connected to a plurality of video distribution systems each including a transmission device transmitting video data, a receiving device receiving the video data, and an HDMI cable connecting the transmission device and the receiving device to each other, the server device comprising:
a receiving unit configured to receive first data that is transmitted by the transmission device included in each of the plurality of video distribution systems and that indicates a type and a capability related to video transmission, of the receiving device, and a type and a capability related to video transmission, of the HDMI cable;
an aggregation unit configured to:
aggregate the plurality of elements of the received first data, for each combination of the type of the receiving device and the type of the HDMI cable that is indicated by each element of the first data, and
store the first data in a memory; and
a transmission unit configured to:
select a video format optimum for the video distribution system including the transmission device transmitting particular first data, based on first data which is indicated by the received particular first data and which indicates the same combination as a combination of the type of the receiving device and the type of the HDMI cable, among the plurality of elements of the first data stored in the memory, and
transmit second data to cause the optimum video format to be selected to the transmission device transmitting the particular first data.

2. The server device of claim 1, wherein
the transmitting unit is configured to select the optimum video format, based on first data in which the error rate indicated as the capability related to the video transmission of the receiving device indicates a value smaller than or equal to a threshold value, among the plurality of elements of the first data stored in the memory.

3. The server device of claim 2, wherein
the transmitting unit is configured to select the optimum video format, based on first data in which the error rate indicates a value smaller than or equal to the threshold value and in which resolution of the video format indicated as the capability related to the video transmission of the receiving device indicates a highest value, among the plurality of elements of the first data stored in the memory.

4. The server device of claim 2, wherein
the threshold value is set to a value based on a standard specification of HDMI.

5. The server device of claim 1, wherein
the first data indicates at least EDID of the receiving device, a video format of the video data received by the receiving device, the error rate of the video data received by the receiving device, and a cable ID of the HDMI cable.

6. A method applicable to a server device communicably connected to a plurality of video distribution systems each including a transmission device transmitting video data, a receiving device receiving the video data, and an HDMI cable connecting the transmission device and the receiving device, the method comprising:
receiving first data that is transmitted by the transmission device included in each of the plurality of video distribution systems and that indicates a type and a capability related to video transmission, of the receiving device, and a type and a capability related to video transmission, of the HDMI cable;
aggregating the plurality of elements of the received first data, for each combination of the type of the receiving device and the type of the HDMI cable that is indicated by each element of the first data, and storing the first data in a memory; and
selecting a video format optimum for the video distribution system including the transmission device transmitting particular first data, based on first data indicating the same combination as a combination of the type of the receiving device and the type of the HDMI cable which is indicated by the received particular first data among the plurality of elements of the first data stored in the memory, and transmitting second data to cause the optimum video format to be selected to the transmission device transmitting the particular first data.

7. The method of claim 6, wherein
the selecting includes selecting the optimum video format, based on first data in which the error rate indicated as the capability related to the video transmission of the receiving device indicates a value smaller than or equal to a threshold value, among the plurality of elements of the first data stored in the memory.

8. The method of claim 7, wherein
the selecting includes selecting the optimum video format, based on first data in which the error rate indicates a value smaller than or equal to the threshold value and in which resolution of the video format indicated as the capability related to the video transmission of the receiving device indicates a highest value, among the plurality of elements of the first data stored in the memory.

9. The method of claim 7, wherein
the threshold value is set to a value based on a standard specification of HDMI.

10. The method of claim 6, wherein
the first data indicates at least EDID of the receiving device, a video format of the video data received by the receiving device, the error rate of the video data received by the receiving device, and a cable ID of the HDMI cable.

11. A transmission device transmitting video data to a receiving device connected using an HDMI cable, the transmission device comprising:
a first transmission unit configured to select a particular video format and transmitting the video data to the receiving device;
a second transmission unit configured to:
acquire from the receiving device data indicating a type and a capability related to video transmission, of the receiving device, and data indicating a type and a capability related to video transmission, of the HDMI cable,
generate first data by attaching a device ID for specifying the transmission device to the data acquired from the receiving device and the data acquired from the HDMI cable, and
transmit the first data to a communicably connected server device; and
a receiving unit configured to:
receive from the server device second data indicating an optimum video format of the video data transmitted to the receiving device via the HDMI cable, and
cause the first transmitting unit to select the optimum video format indicated by the second data as the particular video format.

12. The transmission device of claim 11, wherein
the receiving unit is configured to notify a user that the optimum video format is selected by the first transmitting unit.

13. The transmission device of claim 12, wherein
the receiving unit is configured to cause the transmission device or the receiving device to display a screen to notify the user that the optimum video format is selected by the first transmitting unit.

14. The transmission device of claim 11, wherein
the second transmitting unit is configured to generate the first data in every predetermined period and transmit the first data to the server device.

15. The transmission device of claim 11, wherein
the first data indicates EDID of the receiving device, a video format of the video data received by the receiving device, an error rate of the video data received by the receiving device, a cable ID of the HDMI cable, and a device ID of the transmission device.
